(19) United States
(12) Patent Application Publication
(10) Pub. No.: US 2026/0254204 A1
(43) Pub. Date: Aug. 27, 2026

(54) SPARK PLUG WITH IMPROVED GROUND ELECTRODE

(71) Applicant: Robert Bosch GmbH, Stuttgart (DE)

(72) Inventors: Daniel Schoenherr, Bamberg (DE); Manfred Roeckelein, Kemmern (DE); Moritz Wenk, Stuttgart (DE); Paul Justus Sieffert, Stuttgart (DE); Stephan Kaske, Sternenfels Diefenbach (DE)

(21) Appl. No.: 18/995,507

(22) PCT Filed: Jul. 13, 2023
(86) PCT No.: PCT/EP2023/069438

§ 371 Date: Jan. 16, 2025

(30) Foreign Application Priority Data
Jul. 18, 2022 (DE) 10 2022 207 313.4

(51) Int. Cl. H01T 13/32

(52) U.S. Cl. CPC H01T 13/32

(57) ABSTRACT

A spark plug. The spark plug includes a metallic housing, an insulator, a central electrode, and a ground electrode which is positioned laterally to the central electrode, having a main part and a precious metal element, wherein the main part has a fixing region for fixing the ground electrode on the housing and a welding region, and the precious metal element is arranged on the welding region using welded connection. A first transition region is arranged between the fixing region and the welding region, and the cross-sectional surface area of the fixing region is larger than a cross-sectional area of the welding region. The first transition region has a specified extension in the axial direction Y-Y of the ground electrode and provides a geometric connection and a functional separation between the fixing region and the welding region.

### FIELD

The present invention relates to a spark plug with an improved ground electrode. In particular, the present invention relates to a prechamber spark plug with an improved ground electrode.

### BACKGROUND INFORMATION

Spark plugs of different designs are described in the related art. In the case of laterally positioned ground electrodes, which are arranged, for example, at an angle of 90° to the central electrode of the spark plug, the use of precious metal elements on the end face of the ground electrode facing the central electrode leads to problems with the fastening of the precious metal element, on the one hand, and with the actual fastening of the ground electrode, on the other hand. The ground electrode is usually fixed to a housing of the spark plug. The precious metal element is usually connected to the base material of the ground electrode by means of a welded connection. In particular, the welded connection between the precious metal element and the base material of the ground electrode can cause undesirable changes to the base material, particularly in the region in which the ground electrode is to be fastened. However, in addition to possible assembly problems, for example due to a deteriorated interface between the base material and the housing of the spark plug, this also results in further problems relating to heat conduction or the conduction of electrical current.

### SUMMARY

A spark plug according to the present invention may have an advantage that a functional separation between a fixing of a ground electrode to a housing, on the one hand, and a fastening of a precious metal element to the ground electrode, on the other hand, is possible. Here, according to an example embodiment of the present invention, a geometric separation is effected between a fixing region, at which the ground electrode is fixed to a housing, and a welding region, at which a precious metal element is welded to a main part of the ground electrode. As a result, it is possible according to the present invention that, due to the separation between the fixing region and the welding region, the respective interfaces of these regions can be optimized independently of one another by means of special geometric measures. In other words, the fixing region can be given an optimal geometric shape for fixing the ground electrode. The welding region can have an optimal geometric shape for attaching the precious metal element. Furthermore, other functionalities of these regions, such as heat conduction, conduction of electrical current, strength of the regions, can also be optimized, so that the ground electrode can be designed in particular for the entire service life of the spark plug. A further major advantage of the spark plug according to the present invention is that it is possible to mount the ground electrode on the housing, without possibly negatively influencing the welding region of the ground electrode. In particular, the spark plug according to the present invention makes it possible for the ground electrode to be fixed to the housing before attachment of the precious metal element. Alternatively, the spark plug according to the present invention also makes an assembly possible such that first the precious metal element is fastened to the main part of the ground electrode and then the ground electrode provided with the precious metal element is fixed to the housing.

This is achieved according to an example embodiment of the present invention by the spark plug comprising a metallic housing, an insulator, a central electrode and a ground electrode with a main part and a precious metal element. The ground electrode is positioned laterally in relation to the central electrode. The main part of the ground electrode comprises a fixing region for fixing the ground electrode to the housing and a welding region to which a precious metal element, in particular a cylindrical precious metal pin, is fastened by means of a welded connection. A first transition region is arranged between the fixing region and the welding region of the ground electrode, which has a predetermined extension in the axial direction Y-Y of the ground electrode. A cross-sectional area of the fixing region is larger than a cross-sectional area of the welding region of the ground electrode. The first transition region also ensures a geometric connection and a functional separation between the fixing region and the welding region.

Preferred developments of the present invention are disclosed herein.

According to an example embodiment of the present invention, particularly preferably, the main part of the ground electrode, to which the precious metal element is fastened, is a formed part. As a result, the main part of the ground electrode can be produced particularly cost-effectively and different regions of the main part can, due to the forming process, be optimally optimized with regard to their respective functionality. For example, the fixing region can be optimized by the forming process with regard to its fixing properties relating to geometric dimensions and surface qualities. The welding region can also be optimized with regard to its functionality for welding on the precious metal element, both geometrically and relating to its surface properties.

According to an example embodiment of the present invention, particularly preferably, the fixing region of the ground electrode is formed as a cylinder with a first diameter D1 and the welding region as a cylinder with a second diameter D2. The first transition region is preferably provided as a truncated cone, where D1>D2.

Further preferably, according to an example embodiment of the present invention, a first axial length L1 of the fixing region in the axial direction Y-Y is greater than a second axial length L2 of the welding region. As a result, it is ensured that the fixing region is longer than the welding region, thus allowing for simple and secure fixing. Alternatively, the first length L1 is greater than a third length L3 of the first transition region and the third length L3 is greater than the second length L2 of the welding region. This ensures a sufficient distance between the welding region and the fixing region, so that the attachment of the precious metal element by welding does not adversely affect the fixing region. Further alternatively, the first length L1 of the fixing region is greater than the second length L2 of the welding region and the second length L2 of the welding region is greater than the third length L3 of the first transition region. The third length L3 is selected in particular such that negative influences of the welding process for fastening the precious metal element do not affect the fixing region.

According to a further preferred example embodiment of the present invention, the ground electrode further comprises a cylindrical intermediate region, which is arranged between the fixing region and the welding region. By providing the additional cylindrical intermediate region, an even better separation between the functionalities of the fixing region and the welding region can be achieved.

Preferably, the first transition region is arranged between the cylindrical intermediate region and the fixing region and connects these regions directly to one another. Alternatively, the first transition region is arranged between the cylindrical intermediate region and the welding region and connects these regions directly to one another.

According to a further preferred alternative of the present invention, the first transition region is arranged between the cylindrical intermediate region and the fixing region and a second transition region is arranged between the cylindrical region and the welding region.

According to yet another alternative of the present invention, the welding region is arranged directly at the intermediate region. In other words, there is no transition region between the welding region and the intermediate region.

Further preferably, the welding region is formed as a truncated cone. As a result, in particular, a possible negative heat input into the fixing region during the welding process for fastening the precious metal element can be prevented.

Further preferably, a through-opening is formed in the housing, in which the ground electrode is fixed by means of the fixing region. Preferably, the first length L1 of the fixing region is greater than an axial length L0 of the through-opening.

Further preferably, the ground electrode has a copper core. The copper core is preferably cylindrical and runs through the entire main part of the ground electrode up to the precious metal element.

Further preferably, the housing comprises a threaded section, which is configured for a screwed connection to a cylinder head. The through-opening is preferably formed in the threaded portion or, alternatively, the through-opening is arranged outside the threaded section.

Further preferably, one or more transitions between the regions on the ground electrode are formed to be rounded. As a result, an edge-free transition between the individual regions of the ground electrode is possible, so that in particular mounting the ground electrode in the housing can be significantly simplified.

Further preferably, the first and/or second transition regions are formed as a truncated cone.

Preferably, a nickel alloy is used as the material of the ground electrode.

Further preferably, the spark plug is formed as a prechamber spark plug with a prechamber in which the ground electrode is arranged. The prechamber is preferably at least partially defined by a cap in which overflow holes are formed.

### BRIEF DESCRIPTION OF THE DRAWINGS

In the following, preferred exemplary embodiments of the present invention are described in detail with reference to the figures.

FIG. 1 is a schematic sectional view of a spark plug according to a first exemplary embodiment of the present invention.

FIG. 2 is a schematic, enlarged partial sectional view of a ground electrode of the spark plug of FIG. 1.

FIG. 3 is a schematic, enlarged partial sectional view of a ground electrode of a spark plug according to a second exemplary embodiment of the present invention.

FIG. 4 is a schematic representation of the ground electrode of FIG. 3.

FIG. 5 is a schematic sectional view of a ground electrode according to a third exemplary embodiment of the present invention.

FIG. 6 is a schematic representation of the ground electrode of FIG. 5.

FIG. 7 is a schematic, enlarged partial sectional view of a ground electrode of a spark plug according to a second fourth exemplary embodiment of the present invention.

### DETAILED DESCRIPTION OF EXAMPLE EMBODIMENTS

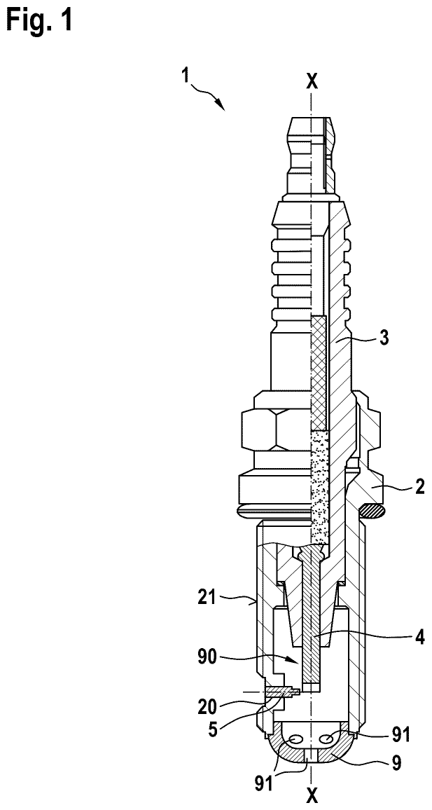

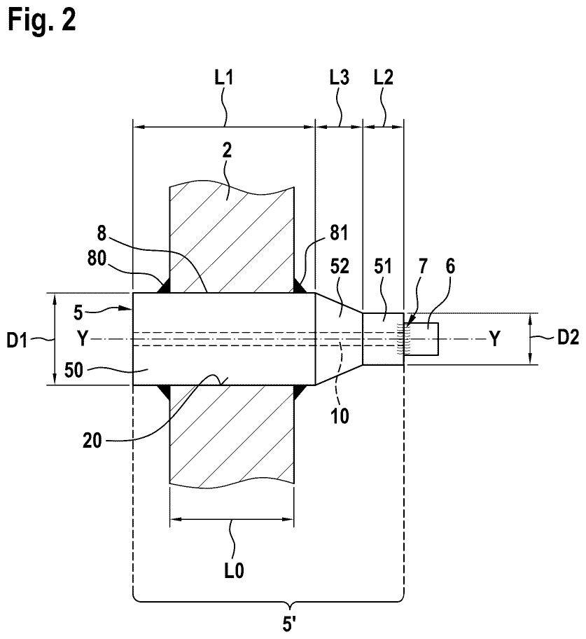

With reference to FIGS. 1 and 2, a spark plug 1 according to a first preferred exemplary embodiment of the present invention is described in detail below.

As can be seen from FIG. 1, the spark plug 1 of the first exemplary embodiment is a prechamber spark plug.

The spark plug 1 comprises a metallic housing 2 and an insulator 3. The spark plug further comprises a central electrode 4 and a ground electrode 5.

The ground electrode 5 is positioned laterally in relation to the central electrode 4.

The spark plug further comprises a cap 9, which together with parts of the housing 2 defines a prechamber 90. The ground electrode 5 and the central electrode 4 are arranged in the prechamber 90.

The housing 2 further comprises an external thread 21, which is configured to be screwed into a cylinder head of an internal combustion engine.

As can be seen from FIG. 1, a through-opening 20 in which the ground electrode 5 is arranged is formed in the housing 2 in the region of the thread 21.

A plurality of overflow holes 91 are formed in the cap 9. X-X indicates the center axis of the spark plug.

The ground electrode 5 can also be seen in detail in FIG. 2. The ground electrode 5 comprises a main part 5′ with a cylindrical fixing region 50 and a cylindrical welding region 51 and a precious metal element 6. The fixing region 50 is configured for fixing the ground electrode to the housing 2. More precisely, as can be seen from FIG. 2, the fixing region 50 is arranged in the through-opening 20 in the housing 2. Here, a press-fit connection 8 is provided between the through-opening 20 and the fixing region 50.

A first transition region 52 is formed between the fixing region 50 and the welding region 51. As can be seen from FIG. 2, the first transition region 52 is formed as a truncated cone. The fixing region 50 is a first cylinder and the welding region 51 is a second cylinder. The fixing region 50 has a first diameter D1 which is larger than a second diameter D2 of the welding region 51.

The transition region 52 has a specified extension in the axial direction Y-Y of the ground electrode 5.

The first transition region 52 thus directly connects the fixing region 50 to the welding region 51, wherein the diameter of the frustoconical first transition region 52 reduces from the first diameter D1 to the second diameter D2. Thus, it is ensured that there is a stepless transition from the fixing region 50 to the first transition region 52 and that the transition from the first transition region 52 to the welding region 51 is also formed to be stepless. The transitions between the sub-regions of the ground electrode 5 can also be rounded.

The precious metal element 6 is fixed to the welding region 51. Here, a welded connection 7 is formed between the precious metal element 6, which is formed as a cylindrical precious metal pin, and the welding region 51. The precious metal element 6 is thus welded to the welding region 51.

As is clear from FIG. 2, a cross-sectional area of the fixing region 50 is larger than a cross-sectional area of the welding region 51. The first transition region 52 thus provides a geometric connection between the fixing region 50 and the welding region 51, wherein the first transition region 52 also provides a functional separation between the fixing region 50 and the welding region 51.

In addition, a cylindrical copper core 10 is arranged in the main part 5′ of the ground electrode 5. The copper core 10 runs from the end face of the welding region 51 to the free end at the fixing region 50. After the precious metal element 6 has been welded on, the copper core 10 is in direct contact with the precious metal element 6.

The function of the fixing region 50 here is to securely fix the ground electrode 5 to the housing 2. The function of the welding region 51 is to securely fix the precious metal element 6 to the ground electrode 5.

The ground electrode 5 thus comprises the precious metal element 6 and the main part 5′, which comprises the fixing region 50, the welding region 51 and the first transition region 52. The main part 5′ is produced in one piece as a formed part, so that no welded connection between the individual sub-regions of the main part is necessary. During the production of the ground electrode, the main part can thus be provided by a forming process. Here, in particular, the external dimensions and a length of the fixing region 50 can be set very precisely.

This makes it easy to provide a secure press-fit connection between the fixing region 50 and the through-opening 20. In the same way, the forming process can also be used to optimally design the welding region 51 for a welded connection to the precious metal element 6.

A geometric separation of functional interfaces on the ground electrode can thus be achieved, so that the respective sub-regions of the ground electrode can be optimized independently of one another. This results in significantly weakened influences when, for example, the ground electrode is fixed to the fixing region on the housing 2 or the precious metal element 6 is welded to the welding region 51.

As a result, this not only provides advantages with regard to fixing the ground electrode or fastening the precious metal element 6, but also further provides advantages with regard to heat conduction and/or conduction of electrical current and/or strength of the main part of the ground electrode. For example, during a welding process for fastening the precious metal element 6, the fixing region 50 is not affected. Here, it is possible for the precious metal element 6 to be fastened to the main part 5′ of the ground electrode before the ground electrode is mounted in the housing, or for the main part 5′ to be fastened to the housing first and then for the precious metal element 6 to be welded on.

The accuracy of a cylindrical shape of the fixing region 50 can thus be increased and, due to production by means of the forming process, an improved coaxiality between the sub-regions of the ground electrode can be achieved, along with an improvement with regard to heat conduction between the fixing region and the housing 2. As a result, an unacceptable increase in temperature of the ground electrode during operation is reliably prevented.

During the process of welding the precious metal element 6 to the welding region 51, any changes in the diameter of the welding region 51 that may occur, in particular an increase in diameter, can be tolerated due to the separation of the regions according to the present invention, since this has no effect on the fixing region 50. This makes it possible to use fast and cost-effective welding processes to fix the precious metal element to the welding region, since the risk of a geometric change in the fixing region caused by the welding is eliminated.

In addition, in the production of the main part 5′ of the ground electrode 5, there is an advantage in that the fixing region 50 can be produced with the highest precision in a first step, in particular by forming, and only after this is the welding region 51 produced. This makes it possible to produce the ground electrode with greater shape tolerances in the individual regions and increases the precision of the component.

The transition region 52 of the first exemplary embodiment is conical. However, it should be noted that other geometric shapes are also possible. Preferably, however, the ground electrode is produced to be rotationally symmetrical, which significantly reduces production costs.

As can be further seen from FIG. 2, a first axial length L1 of the fixing region 50 in the axial direction Y-Y of the ground electrode 5 is greater than a second axial length L2 of the welding region 51. Furthermore, the first length L1 is also greater than a third axial length L3 of the first transition region 52.

Moreover, an axial length L0 of the through-opening 20, which corresponds to a thickness of the housing in the region of the prechamber, is less than the first length L1 of the fixing region 50. This makes it possible, for example, in a simple manner to realize welded connections 80, 81 between the fixing region 50 and the housing 2 in addition to the press-fit connection 8 between the fixing region 50 and the through-opening 20. A welded connection can be made at the free end of the fixing region 50, which is located on the outside of the housing 2 and/or on the inside of the housing at the fixing region 50.

The main part of the ground electrode 5 can thus be manufactured from one workpiece, wherein preferably the fixing region 50 is produced first and only then the first transition region 52 and the welding region 51, preferably by means of a forming process.

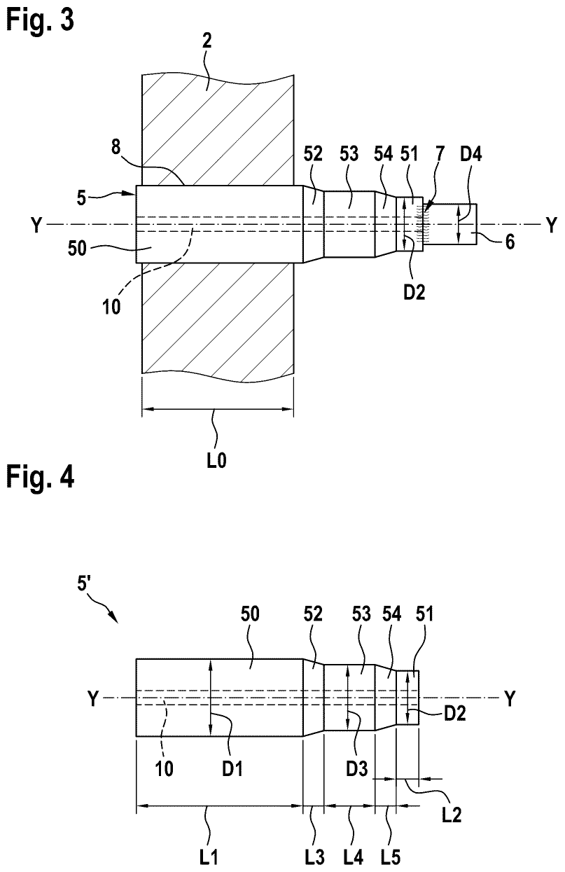

FIGS. 3 and 4 show a spark plug 5 according to a second exemplary embodiment of the present invention. Identical or functionally identical parts are denoted by the same reference signs as in the first exemplary embodiment.

As can be seen from FIG. 3, the structure of the ground electrode 5 of the second exemplary embodiment is different.

In addition to the fixing region 50, the welding region 51 and the first transition region 52, the ground electrode 5 of the second exemplary embodiment comprises a cylindrical intermediate region 53 and a second transition region 54. The second intermediate region 53 is arranged between the fixing region 50 and the welding region 51. The first transition region 52 connects the fixing region 50 directly to the cylindrical intermediate region 53. The second transition region 54 directly connects the cylindrical intermediate region 53 to the welding region 51. At the welding region 51, a precious metal element 6 is fixed to its end face by means of a welded connection 7. The precious metal element 6 has a fourth diameter D4, which is less than a second diameter D2 of the welding region 51.

FIG. 4 shows the main part 5′ in detail. The first axial length L1 of the fixing region 50 is greater than the second axial length L2 of the welding region 51 and the first length L1 is also greater than a fourth axial length L4 of the cylindrical intermediate region 53. Preferably, a conicity of the first transition region 52 at a smaller angle than that of the second transition region 54, which has a fifth length L5, is also the same.

The main part 5′ of the ground electrode 5 of the second exemplary embodiment is preferably also a one-piece component which is produced from a preliminary product by means of a plurality of forming processes.

A first diameter D1 of the fixing region 50 is furthermore greater than a second diameter D2 of the welding region 51 and also greater than a third diameter D3 of the cylindrical intermediate region 53. The third diameter D3 is furthermore greater than the second diameter D2.

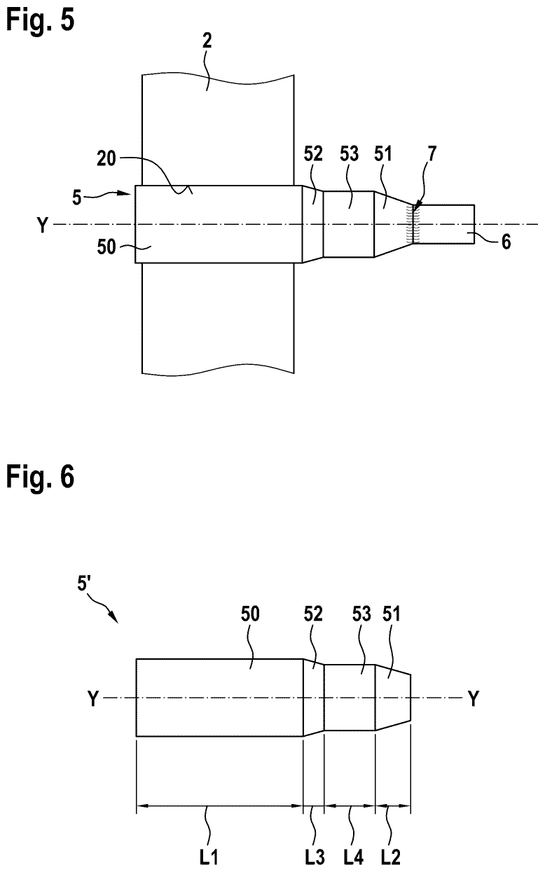

FIGS. 5 and 6 show a spark plug according to a third exemplary embodiment of the present invention. Identical or functionally identical parts are denoted by the same reference signs as in the above-described exemplary embodiments.

The third exemplary embodiment substantially corresponds to the second exemplary embodiment, wherein, in contrast to the second exemplary embodiment, no second transition region is provided in the third exemplary embodiment. As can be seen from FIGS. 5 and 6, the welding region 51 is arranged directly at the cylindrical intermediate region 53. Thus, the second transition region can be omitted. The welding region 51 here is formed as a truncated cone. The main part 5′ is again a one-piece component which is produced from a preliminary product in a plurality of forming steps. After the main part has been produced, the precious metal element 6 can then be welded to the end face of the welding region 51.

Otherwise, this exemplary embodiment corresponds to the above-described exemplary embodiments, so that reference can be made to the description given there.

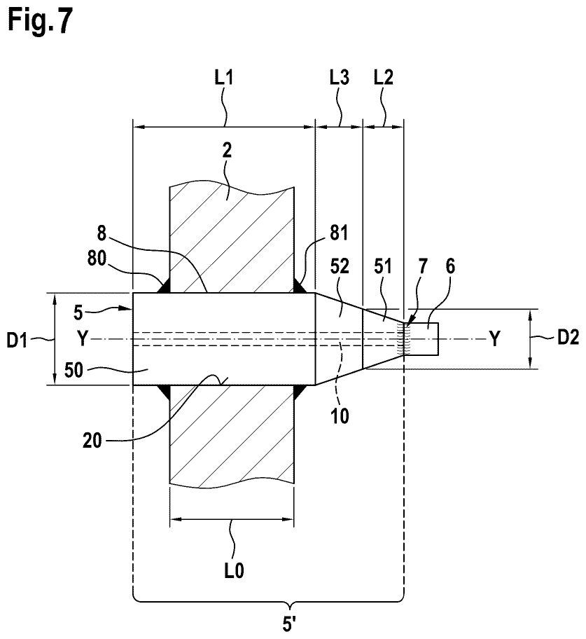

FIG. 7 shows a ground electrode of a spark plug according to a fourth exemplary embodiment of the present invention. Identical or functionally identical parts are denoted by the same reference signs as in the above-described exemplary embodiments.

As can be seen from FIG. 7, the fourth exemplary embodiment substantially corresponds to the second exemplary embodiment, wherein, in contrast to the second exemplary embodiment, in the fourth exemplary embodiment the welding region 51 is formed as a truncated cone. The frustoconical welding region 51 directly adjoins the first transition region 52. Here, a cone angle of the frustoconical welding region 51 and of the transition region 52 is the same. It should be noted, however, that the angle can also be selected to be different.

1-14. (canceled)

15. A spark plug, comprising:
a metallic housing;
an insulator;
a central electrode; and
a ground electrode which is positioned laterally in relation to the central electrode and has a main part and a precious metal element;
wherein the main part has a fixing region for fixing the ground electrode to the housing and a welding region, wherein the precious metal element is arranged on the welding region by a welded connection,
wherein a first transition region is arranged between the fixing region and the welding region,
wherein a cross-sectional area of the fixing region is larger than a cross-sectional area of the welding region, and
wherein the first transition region has a specified extension in an axial direction of the ground electrode and provides a geometric connection and a functional separation between the fixing region and the welding region.

16. The spark plug according to claim 15, wherein the main part of the ground electrode is a one-piece formed part.

17. The spark plug according to claim 15, wherein the fixing region is a cylinder with a first diameter, the welding region is a cylinder with a second diameter, and the first transition region is a truncated cone.

18. The spark plug according to claim 15, wherein:
(i) a first length of the fixing region in the axial direction is greater than a second length of the welding region, or
(ii) the first length of the fixing region in the axial direction is greater than a third length of the first transition region, and the third length is greater than the second length of the welding region, or
(iii) the first length of the fixing region in the axial direction is greater than the second length of the welding region, and the second length is greater than the third length of the first transition region.

19. The spark plug according to claim 15, further comprising:
a cylindrical intermediate region which is arranged between the fixing region and the welding region.

20. The spark plug according to claim 19, wherein:
(i) the first transition region connects the cylindrical intermediate region to the fixing region, or
(ii) the first transition region connects the cylindrical intermediate region to the welding region.

21. The spark plug according to claim 19, wherein:
(i) the first transition region connects the cylindrical intermediate region to the fixing region, and
(ii) a second transition region connects the cylindrical intermediate region to the welding region.

22. The spark plug according to claim 19, wherein the welding region is arranged directly at the cylindrical intermediate region.

23. The spark plug according to claim 15, wherein the welding region is formed as a truncated cone.

24. The spark plug according to claim 15, wherein:
(i) a through-opening is formed in the housing, in which the ground electrode is fixed by a press-fit connection, and/or
(ii) the ground electrode is connected to the housing by one or more welded connections.

25. The spark plug according to claim 24, wherein a first length of the fixing region is greater than an axial length of the through-opening.

26. The spark plug according to claim 15, wherein the ground electrode has a copper core.

27. The spark plug according to claim 15, wherein the housing has a threaded portion and the ground electrode is fastened in a region of the threaded portion.

28. The spark plug according to claim 15, wherein the spark plug is formed as a prechamber spark plug with a prechamber.
